(19) United States
(12) Patent Application Publication
(10) Pub. No.: US 2023/0125097 A1
(43) Pub. Date: Apr. 27, 2023

(54) PHOTOGRAPHY SUPPORT DEVICE AND METHOD, AND COMPUTER-READABLE STORAGE MEDIUM

(71) Applicants: NTT Communications Corporation, Tokyo (JP); 3i, Inc, Seoul (KR)

(72) Inventor: Ken KIM, Seoul (KR)

(73) Assignees: NTT Communications Corporation, Tokyo (JP); 3i, Inc, Seoul (KR)

(21) Appl. No.: 18/145,878

(22) Filed: Dec. 23, 2022

Related U.S. Application Data
(63) Continuation of application No. PCT/JP2021/018535, filed on May 17, 2021.

(30) Foreign Application Priority Data
Jul. 1, 2020 (JP) 2020-114277

(51) Int. Cl. G06T 11/60; H04N 23/60; G06T 7/70

(52) U.S. Cl. CPC G06T 11/60; H04N 23/64; G06T 7/70; G06T 2207/30244

(57) ABSTRACT

Optimization of a photography position is intended. According to one embodiment, photography recommended positions are sequentially set based on reference points set on a two-dimensional coordinate plane of a plan view of a floor to be photographed, a graphic pattern representing a set photography recommended position is combined with a finder display image output from a camera CM to thereby generate photography guide information composed of an AR image, and the generated photography guide information is transmitted to the user terminal MT and displayed. In addition, it is determined whether or not the movement position of the user is within a predetermined range including the photography recommended position. If the photography is performed outside the predetermined range, a message is displayed to that effect or notification is given by vibrating a vibrator, and the image data photographed at this time is discarded.

### CROSS REFERENCE TO RELATED APPLICATIONS

This application is a Continuation Application of PCT Application No. PCT/JP2021/018535, filed May 17, 2021 and based upon and claiming the benefit of priority from Japanese Patent Application No. 2020-114277, filed Jul. 1, 2020, the entire contents of all of which are incorporated herein by reference.

### FIELD

Embodiments described herein relate generally to a photography support device and method, and to a computer-readable storage medium for supporting a photographing action, for example, by a photographer.

### BACKGROUND

In recent years, techniques have been proposed for managing facilities, such as business facilities, offices and residences using images thereof. For example, Patent Literature 1 describes a technique in which a three-dimensional (3D) image showing the inside of a facility is generated by photographing a three-dimensional space of the facility in all directions (360°) from a plurality of different positions, recording the obtained images in a storage medium, and connecting the recorded images. The use of this technique enables a facility manager or a user to remotely grasp the state of the facility from the 3D images without the need to go to the site.

### PATENT LITERATURE

Patent Literature 1: U.S. Patent Application Publication No. 2018/0075652

In the conventionally proposed system, however, it is the judgment of the photographer to decide which portion of the three-dimensional space is to be photographed. For this reason, important locations may not be photographed, and there may be discontinuous portions in a reproduced 3D image.

The present embodiment has been made with the above circumstances taken into consideration, and is intended to provide a technique for optimizing photography positions.

In order to solve the above problems, a photography support device or photography support method according to the first aspect sets a reference point of a photography position in a space to be photographed such that the reference point is on a two-dimensional coordinate plane of the space, sets at least the next photography recommended position, based on the set reference point and information representing the two-dimensional coordinate plane, and generates and outputs information which presents the set photography recommended position to the photographer.

That is, according to one aspect, a photography recommended position can be presented to the photographer, so that photography positions can be optimized.

### BRIEF DESCRIPTION OF THE DRAWINGS

FIG. 1 is a schematic configuration diagram of a system including a server device that operates as a photography support device according to one embodiment.

FIG. 2 is a block diagram showing an example of a hardware configuration of a server device employed in the system shown in FIG. 1.

FIG. 3 is a block diagram showing an example of a software configuration of the server device of the system shown in FIG. 1.

FIG. 4 is a flowchart showing an example of the processing procedures and contents of a photography support operation executed by the server device shown in FIG. 3.

FIG. 5 is a diagram showing an example of a reference point of a photography point set on plan view data and a photography recommended position.

FIG. 6 is a diagram illustrating an example of guide information displayed in a finder image output from a camera and indicating a photography recommended position.

### DETAILED DESCRIPTION

Embodiments will now be described with reference to the accompanying drawings.

### One Embodiment

### Configuration Example

(1) System

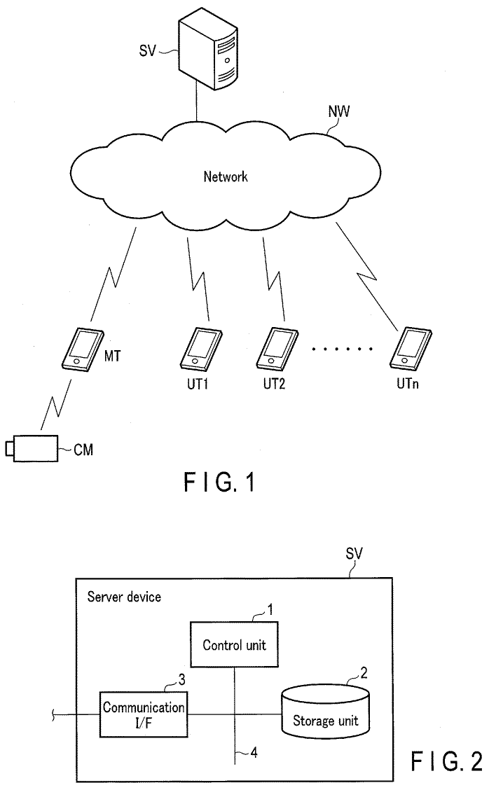

FIG. 1 is a schematic configuration diagram of a system according to one embodiment.

This system includes a server device SV that operates as a photography support device. Data communications are enabled between this server device SV and user terminals MT and UT1 to UTn of users via a network NW.

The user terminals MT and UT1 to UTn include a user terminal MT used by the user who registers omnidirectional images and user terminals UT1 to UTn used by users who browse the registered images. Each of the user terminals is configured as a mobile information terminal, such as a smartphone or a tablet type terminal. It should be noted that a notebook personal computer or a desktop personal computer may be used as a user terminal, and the connection interface to the network NW is not limited to a wireless type but may be a wired type.

The user terminal MT is capable of data transmission with a camera CM, for example, via a signal cable or via a low-power wireless data communication interface such as Bluetooth (registered trademark). The camera CM is a camera capable of photographing in all directions, and is fixed, for example, to a tripod capable of maintaining a constant height position. The camera CM transmits photographed omnidirectional image data to the user terminal MT via the low-power wireless data communication interface.

The user terminal MT also has a function of measuring its current position using signals transmitted, for example, from a Global Positioning System (GPS) or a wireless Local Area Network (LAN). The user terminal MT has a function of enabling the user to manually input position coordinates as a reference point in case the position measurement function cannot be used, as in the case where the user terminal MT is in a building.

Each time the user terminal MT receives omnidirectional image data photographed at one position from the camera CM, the user terminal MT calculates position coordinates indicative of the photography position, based on the position coordinates of the reference point and the moving distance and moving direction measured by built-in motion sensors (e.g., an acceleration sensor and a gyro sensor). The received omnidirectional image data is transmitted to the server device SV via the network NW together with information on the calculated photography position coordinates and photographing date and time. These processes are executed by pre-installed dedicated applications.

The user terminals UT1 to UTn have browsers, for example. Each user terminal has a function of accessing the server device SV by means of a browser, downloading an image showing how a desired place of a desired facility and floor is at a desired date and time in response to a user's input operation, and displaying the downloaded image on a display.

The network NW is composed of an IP network including the Internet and an access network for accessing this IP network. For example, a public wired network, a mobile phone network, a wired LAN, a wireless LAN, Cable Television (CATV), etc. are used as the access network.

(2) Server Device SV

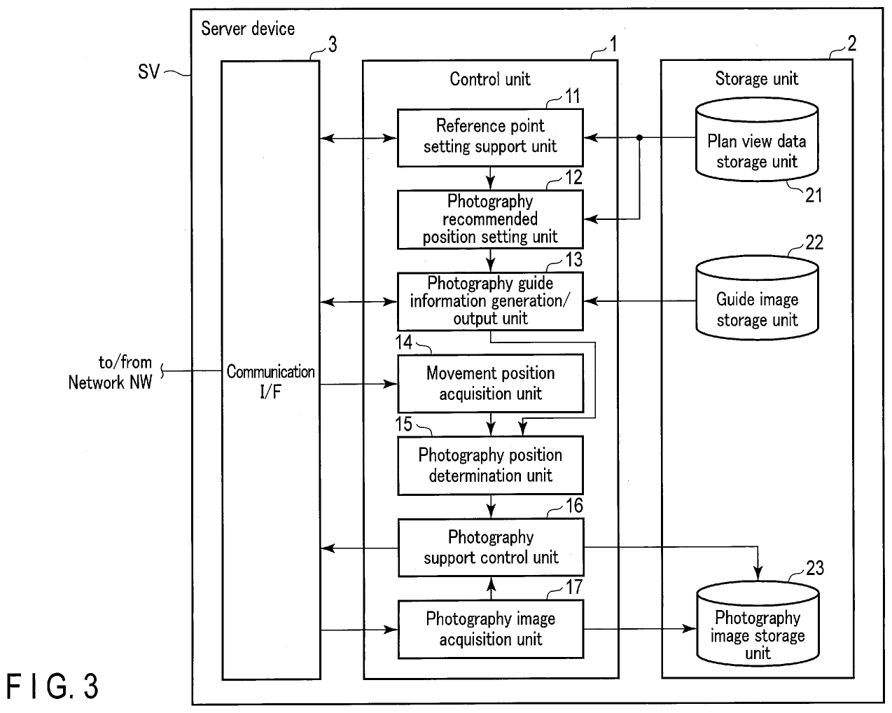

FIGS. 2 and 3 are block diagrams that show the hardware and software configurations of the server device SV, respectively.

The server device SV is composed of a server computer installed on the cloud or on the Web, and includes a control unit 1 having such a hardware processor as a central processing unit (CPU). A storage unit 2 and a communication interface (communication I/F) 3 are connected to the control unit 1 via a bus 4.

The communication I/F 3 transmits and receives data to and from the user terminals MT and UT1 to UTn via the network NW under the control of the control unit 1, and uses a wired network interface, for example.

The storage unit 2 uses, for example, a nonvolatile memory which serves as a main storage medium such as a Hard Disk Drive (HDD) or a Solid State Drive (SSD) and for which data can be written and read at any time. As the storage medium, a Read Only Memory (ROM) and a Random Access Memory (RAM) may be used in combination.

A program storage area and a data storage area are provided in the storage area of the storage unit 2. Programs necessary for executing various control processes related to one embodiment are stored in the program storage area, in addition to middleware such as an Operating System (OS).

In the data storage area, a plan view data storage unit 21, a guide image storage unit 22 and a photography image storage unit 23 are provided as storage units necessary for carrying out one embodiment. In addition, a work storage unit necessary for various processes executed by the control unit 1 is provided.

The plan view data storage unit 21 is used to store the plan view data representing a two-dimensional coordinate plane of each floor of the target facility. The two-dimensional coordinate plane reflects a layout representing how rooms, facilities, etc. are arranged on a floor, and includes information designating an area that has to be photographed or an area that does not have to be photographed.

The guide image storage unit 22 is used to store graphic patterns for displaying photography recommended positions. The graphic pattern is ring-shaped, for example, and is colored in a color different from that of the floor.

The photography image storage unit 23 is used to store all omnidirectional images photographed by the camera CM for each photography position in association with information representing the photographing dates and times and the photography positions.

The control unit 1 includes a reference point setting support unit 11, a photography recommended position setting unit 12, a photography guide information generation/output unit 13, a movement position acquisition unit 14, a photography position determination unit 15, a photography support control unit 16 and a photography image acquisition unit 17, which are control processing functions according to one embodiment. Each of these processing units 11 to 17 is implemented by causing a hardware processor to execute a program stored in the program storage area of the storage unit 2.

The reference point setting support unit 11 transmits plan view data of the floor of a photography target to the user terminal MT. Based on this plan view data, position coordinate data representing a reference point of a photography position (referred to as a photography point as well) manually set by the user is obtained, and the position coordinate data is stored in the storage area of the control unit 1.

Based on the position coordinate data of the set reference point and the two-dimensional coordinates of the plan view data of the photography target floor stored in the plan view data storage unit 21, the photography recommended position setting unit 12 calculates and determines the next photography recommended position.

In order to present the photography recommended position set by the photography recommended position setting unit 12 to the user, the photography guide information generation/output unit 13 synthesizes a guide image read from the guide image storage unit 22 with a finder image which the camera CM outputs before photographing, thereby generating photography guide information composed of an augmented reality (AR) image, and transmits the generated photography guide information to the user terminal MT.

In order to manage the movement of the user's photography position, the movement position acquisition unit 14 acquires from the user terminal MT movement information representing the user's moving distance and moving direction measured by distance sensors (for example, an acceleration sensor and a gyro sensor) of the user terminal MT.

The photography position determination unit 15 calculates position coordinates of the user after the movement, based on the acquired movement information, and compares the calculated position coordinates with the coordinates of the photography recommended position set by the photography recommended position setting unit 12. Then, it is determined whether or not the coordinates of the movement position are within a predetermined range including the coordinates of the photography recommended position.

Based on the determination result of the photography position determination unit 15, the photography support control unit 16 generates notification information for notifying the user of the determination result and transmits the notification information to the user terminal MT. If photography is performed in a state in which the coordinates of the movement position are not within the range including the coordinates of the photography recommended position, the photography support control unit notifies the user terminal MT to this effect and discards the image photographed at this time.

Each time the photography image data photographed at each photography recommended position is sent from the user terminal MT, the photography image acquisition unit 17 receives the photography image data via the communication I/F 3, and stores the received data in the photography image storage unit 23 in association with information representing the photography position coordinates and the photographing date and time which are received together with the image data.

### Operation Example

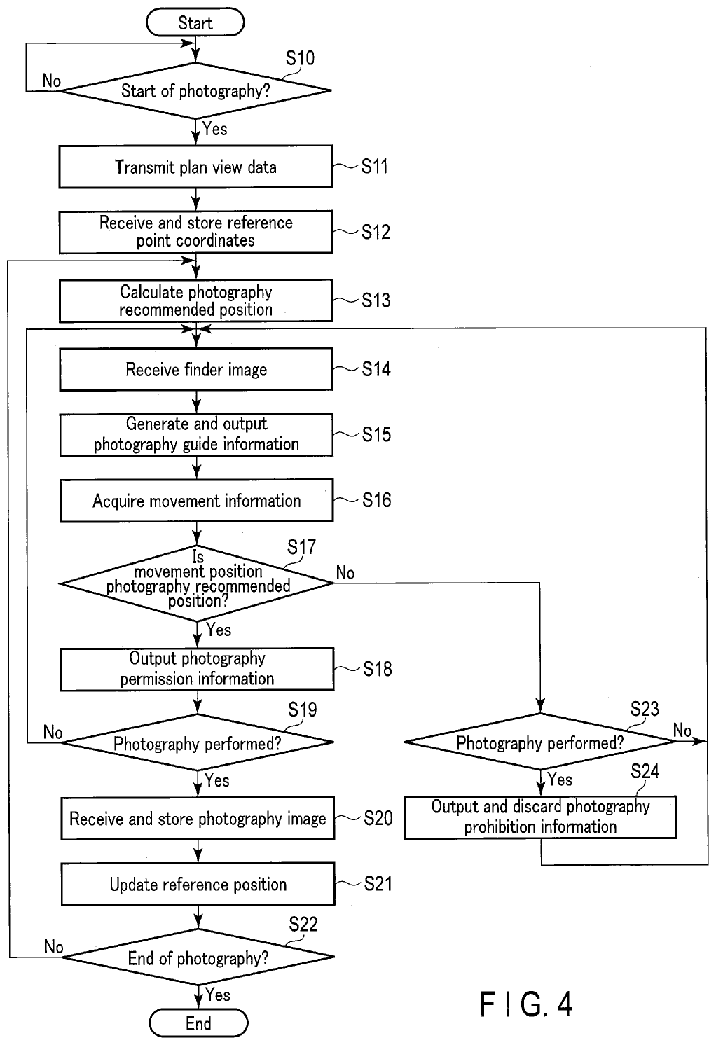

Next, an operation example of the server device SV configured as described above will be described. FIG. 4 is a flowchart showing an example of the processing procedure and processing contents.

(1) Acquisition of Reference Point

Where a request to start photography is transmitted from the user terminal MT in order to start photographing a photography target floor, the server device SV detects a photography start request in step S10, and performs the following processing for acquiring a reference point.

That is, under the control of the reference point setting support unit 11, the server device SV first reads plan view data of the photography target floor from the plan view data storage unit 21 in step S11, and transmits the read plan view data to the request-making user terminal MT via the communication I/F 3. This plan view data is received by the user terminal MT and displayed on the display.

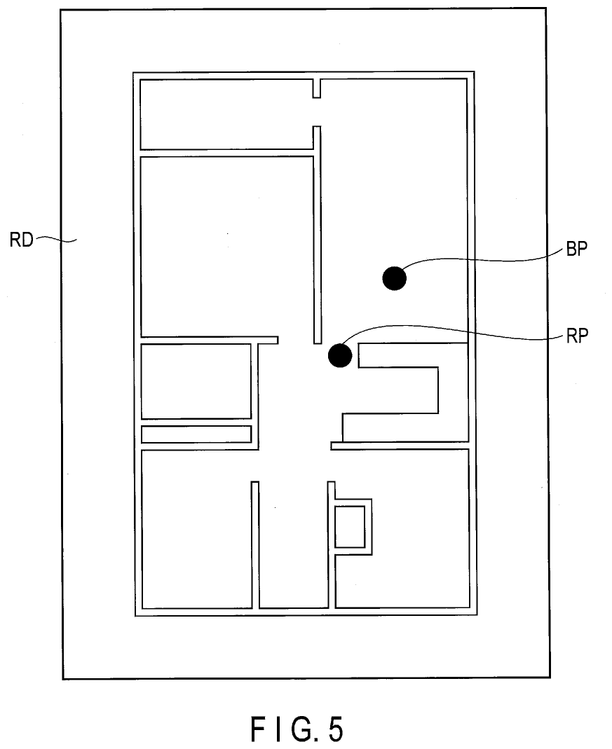

In this state, the user uses the plan view data of the photography target floor and determines a position from which photographing the floor is started as a reference point. For example, where the plan view data of the photography target floor is such data as shown in FIG. 5, the position indicated by BP in the Figure is set as the reference point. Then, the user obtains position coordinates of this reference point from the coordinate system of the plan view data, and inputs them to the user terminal MT. The user terminal MT saves the input position coordinates of the reference point and transmits them to the server device SV. The reference point may be set at any position within the photography target floor.

Where the position coordinate data of the reference point is transmitted from the user terminal MT, the server device SV receives the position coordinate data of the reference point via the communication I/F 3 in step S12 under the control of the reference point setting support unit 11, and stores the position coordinate data in the storage area of the control unit 1.

After the reference point BP is set, if the user performs a photography operation with the camera CM at the reference point BP, photography image data that is obtained with the camera CM in all directions is transmitted to the user terminal MT, and is then transmitted to the server device SV from the user terminal MT. Under the control of the photography image acquisition unit 17, the server device SV receives the photography image data via the communication I/F 3, associates the image data with the photographing date and time and the photography position coordinates (coordinates of the reference point), and stores them in the photography image storage unit 23.

(2) Setting and Presentation of Photography Recommended Position

After completing the acquisition of the position coordinate data on the reference point, the server device SV sets the next photography recommended position under the control of the photography recommended position setting unit 12 in step S12. The photography recommended position is set based on the position coordinate data on the reference point and the two-dimensional coordinate data of the plan view data of the photography target floor stored in the plan view data storage unit 21. More specifically, the photography recommended position is set to be within a preset distance range from the reference point BP, that is, within the range of distance where a 3D image continuous with the omnidirectional image photographed at the reference point BP can be generated. In addition, when the photography recommended position is set, areas on the floor which do not have to be photographed are excluded. This is enabled by referring to designation information indicating which area has to be photographed and which area does not have to be photographed in the plan view data representing the rooms, facilities, etc. of the floor to be photographed. RP in FIG. 5 indicates an example of a photography recommended position which is set as described above.

After the photography recommended position is set, the server device SV subsequently generates information for presenting the photography recommended position to the user, under the control of the photography guide information generation/output unit 13. That is, first, in step S14, the user terminal MT of the photography guide information generation/output unit 13 receives a finder display image output from the camera CM. Then, in step S15, a graphic pattern representing the photography recommended position is read from the guide image storage unit 22, and the read graphic pattern is synthesized at the corresponding position of the finder display image, thereby generating photography guide information composed of an AR image. At this time, the graphic pattern has, for example, a ring shape and is colored in a color different from the color of the floor. In the finder display image, therefore, the photography recommended position is displayed such that it is clearly distinguished from the other portions of the floor.

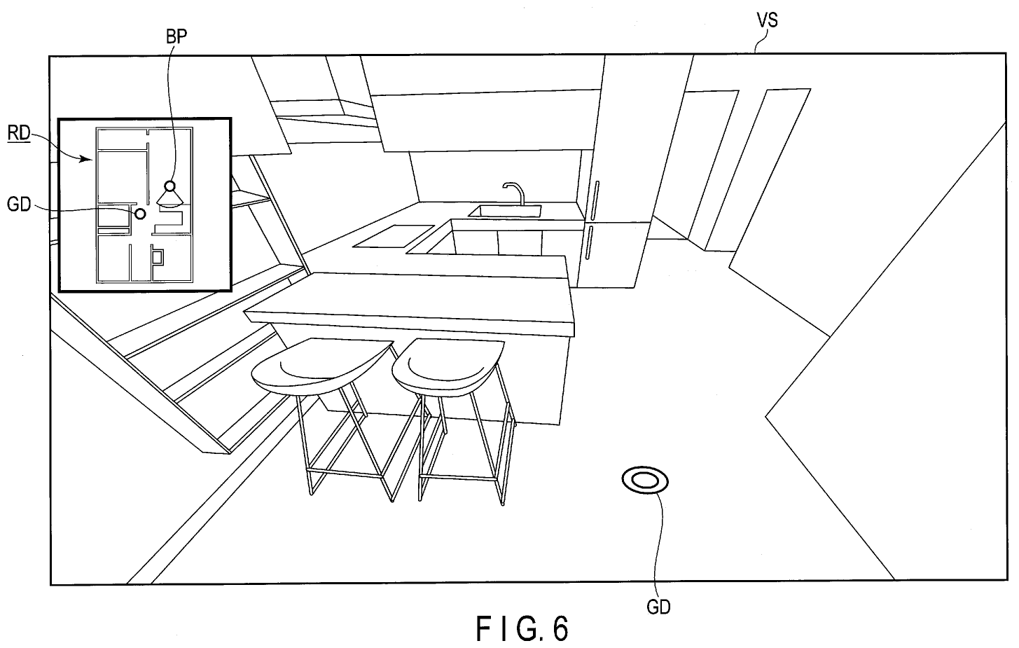

The photography guide information generation/output unit 13 transmits the photography guide information composed of the generated AR image from the communication I/F 3 to the user terminal MT. As a result, the photography guide information sent from the server device SV is displayed on the display of the user terminal MT in place of the finder display image. FIG. 6 shows a display example of the photography guide information, in which GD is a graphic pattern representing a photography recommended position. Therefore, the user can accurately recognize the next photography recommended position from the graphic pattern GD of the photography guide information.

(3) Determination of Whether Photography Position is Appropriate, and Photography Support Processing Based on Determination Result

Where the user moves toward the photography recommended position GD, distance sensors (for example, an acceleration sensor and a gyro sensor) of the user terminal MT detect the movement distance and the movement direction of the user, and movement information representing the detected movement distance and movement direction is transmitted from the user terminal MT to the server device SV.

Under the control of the movement position acquisition unit 14, the server device SV receives the movement information transmitted from the user terminal MT via the communication I/F 3 in step S16. Subsequently, in step S17, under the control of the photography position determination unit 15, the server device SV calculates position coordinates of the user after movement based on the received movement information, and compares the calculated position coordinates with the coordinates of the photography recommended position GD set by the photography recommended position setting unit 12. Then, it is determined whether or not the position coordinates of the user after movement are included within a predetermined range including the coordinates of the photography recommended position GD.

Let it be assumed that as a result of the determination, the position coordinates of the user after movement are included within the predetermined range including the coordinates of the photography recommended position GD. In this case, under the control of the photography support control unit 16, the server device SV generates photography permission information and transmits it from the communication I/F 3 to the user terminal MT in step S18. As a result, in the user terminal MT, a mark or a message indicating that photography is enabled is shown on the display.

Let it be assumed that the user performs a photography operation in this state, and the photography image data is transmitted from the user terminal MT. In step S19, under the control of the photography image acquisition unit 17, the server device SV determines whether or not the image photography has been performed based on the photography image data transmitted from the user terminal MT. After photography is performed, the photography image acquisition unit 17 receives the photography image data via the communication I/F 3 and stores the photography image data in the photography image storage unit 23 in step S20.

Where the image photographed at the photography recommended position GD is acquired, the server device SV updates the reference position to the photography recommended position GD in step S21.

On the other hand, let it be assumed that the position coordinates obtained after movement of the user do not reach a predetermined range including the coordinates of the photography recommended position GD or have passed through that range. In this case, under the control of the photography support control unit 16, the server device SV determines whether or not photography has been performed based on the photography image data transmitted from the user terminal MT in step S23. Where the photography is executed in this state, photography prohibition information is generated under the control of the photography support control unit 16, and the information is transmitted from the communication I/F 3 to the user terminal MT in step S24.

As a result, in the user terminal MT, a mark or a message indicating that the photography that has been performed is inappropriate is displayed on the display. It should be noted that means for vibrating a vibrator or means for lighting a flash may be used as the means for presenting the inappropriate photography.

Under the control of the photography support control unit 16, the server device SV deletes the photography image data stored in the photography image storage unit 23 and photographed at inappropriate positions other than the photography recommended position GD.

In step S22, the server device SV repeats the above-described series of photography support processes for each photography recommended position until it detects a notification indicating that all photography operation for the floor to be photographed has been completed.

### Operations and Advantageous Effects

As described above, according to one embodiment, photography recommended positions are sequentially set based on the reference points set on the two-dimensional coordinate plane of the plan view of the floor to be photographed, a graphic pattern representing a set photography recommended position is combined with the finder display image output from the camera CM to thereby generate photography guide information composed of an AR image, and the generated photography guide information is transmitted to the user terminal MT and displayed. In addition, it is determined whether or not the movement position of the user is within a predetermined range including the photography recommended position. If the photography is performed outside the predetermined range, a message is displayed to that effect or notification is given by vibrating the vibrator, and the image data photographed at this time is discarded.

Therefore, appropriate photography recommended positions can be presented to the user, so that a 3D tour image without omission of important places or photography discontinuity can be generated.

In addition, where the photography recommended position is set, designation information included in the plan view data and representing the rooms, equipment, etc. of the floor to be photographed and indicating which area has to be photographed and which area does not have to be photographed can be referred to, so that the photography recommended position is prevented from being set as a photography unnecessary area. Therefore, useless photography is prevented from being performed in areas where photography is not required, thereby reducing the user's workload and preventing unnecessary photography image data from being stored in the photography image storage unit 23. Therefore, the processing load on the server device SV can be reduced and the memory capacity can be saved.

### Other Embodiments

(1) In the above embodiment, each time a photography image at one photography recommended position is obtained, the next photography recommended position is set and presented. However, when a reference point or one photography recommended position is set, the next photography recommended position and all subsequent photography recommended positions may be set within the range of the finder display image and presented at the same time.

(2) As the graphic patterns representing the photography recommended position, patterns of various shapes other than the ring-shaped pattern can be arbitrarily selected and used, including simple circles ellipses, polygons and squares. Also, the size of the graphic pattern can be arbitrarily set. In particular, if the size of the graphic pattern is set according to a predetermined range including the photography recommended position, an appropriate photography position range can be visually indicated to the user.

(3) In the above embodiment, movement information representing the movement distance and movement direction measured by the user terminal MT is transmitted to the server device SV, and the server device SV calculates the movement position of the user based on the movement information. However, this is not restrictive, and the user terminal MT may calculate the moving position on the two-dimensional coordinate plane of the plan view data of the floor, based on the measured moving distance and moving direction, and the calculated moving position may be transmitted to the server device SV.

(4) In connection with the above embodiment, reference was made to the example in which the function of the photography support device is provided for the server device SV, but that function may be provided for an inter-network connection device such as an edge router or for a user terminal MT. Alternatively, the control unit and the storage unit may be provided separately in different server devices or terminal devices, and these devices may be connected via a communication line or network.

(5) The configuration of the photography support device, the procedures and processing contents of the photography support operation etc. can be variously modified without departing from the gist.

That is, the present invention is not limited to the above-described embodiments and can be embodied in practice by modifying the structural elements without departing from the gist. In addition, various inventions can be made by properly combining the structural elements disclosed in connection with the above embodiments. For example, some of the structural elements may be deleted from the embodiments. Furthermore, structural elements of different embodiments may be combined properly.

### REFERENCE SIGNS LIST

SV: server device
MT, UT1-UTn: user terminal
NW: network
CM: camera
1: control unit
2: storage unit
3: communication I/F
4: bus
11: reference point setting support unit
12: photography recommended position setting unit
13: photography guide information generation/output unit
14: movement position acquisition unit
15: photography position determination unit
16: photography support control unit
17: photography image acquisition unit
21: plan view data storage unit
22: guide image storage unit
23: photography image storage unit

What is claimed is:

1. A photography support device comprising:
a reference point setting unit configured to set a reference point of a photography position in a space to be photographed, such that the reference point is on a two-dimensional coordinate plane of the space;
a recommended position setting unit configured to set at least a next photography recommended position, based on the set reference point and information representing the two-dimensional coordinate plane; and
an output unit configured to generate and output information for presenting the set photography recommended position to a photographer.

2. The photography support device according to claim 1, wherein the information representing the two-dimensional coordinate plane includes two-dimensional coordinate information reflecting layout of the space; and
the recommended position setting unit sets at least the next photography recommended position, based on the reference point and the two-dimensional coordinate information reflecting the layout of the space.

3. The photography support device according to claim 1, wherein the output unit generates a photography support image in which a graphic pattern representing the photography recommended position is displayed in a photography image of the space output from a photography device used by the photographer, and outputs the generated photography support image.

4. The photography support device according to claim 1, further comprising:
a movement information acquisition unit configured to acquire information representing a movement amount and a movement direction of the photographer as measured from the reference point;
a determination unit configured to determine whether or not a position of the photographer after movement is within a predetermined range including the photography recommended position, based on acquired information on the movement amount and the movement direction and the photography recommended position; and
a support operation execution unit configured to execute a photography support operation for the photographer, based on a determination result of the determination unit.

5. The photography support device according to claim 4, wherein the support operation execution unit generates and outputs information for notifying the photographer of the determination result.

6. The photography support device according to claim 5, wherein where the determination unit determines that the position of the photographer is not within the predetermined range and the photographer performs a photography operation in this state, the support operation execution unit generates and outputs information indicating that the photography operation is inappropriate.

7. The photography support device according to claim 5, wherein where the determination unit determines that the position of the photographer is not within the predetermined range and the photographer performs a photography operation in this state, the support operation execution unit discards a photography image obtained by the photography operation.

8. A photography support method executed by an information processing device comprising a processor and a memory, the method comprising:
setting a reference point of a photography position in a space to be photographed, such that the reference point is on a two-dimensional coordinate plane of the space;
setting at least a next photography recommended position, based on the set reference point and information representing the two-dimensional coordinate plane; and
generating and outputting information for presenting the set photography recommended position to a photographer.

9. A non-transitory computer-readable storage medium storing programs for causing a processor of the photography support device recited in claim 1 to execute a process of each unit of the photography support device.

10. A non-transitory computer-readable storage medium storing programs for causing a processor of the photography support device recited in claim 2 to execute a process of each unit of the photography support device.

11. A non-transitory computer-readable storage medium storing programs for causing a processor of the photography support device recited in claim 3 to execute a process of each unit of the photography support device.

12. A non-transitory computer-readable storage medium storing programs for causing a processor of the photography support device recited in claim 4 to execute a process of each unit of the photography support device.

13. A non-transitory computer-readable storage medium storing programs for causing a processor of the photography support device recited in claim 5 to execute a process of each unit of the photography support device.

14. A non-transitory computer-readable storage medium storing programs for causing a processor of the photography support device recited in claim 6 to execute a process of each unit of the photography support device.

15. A non-transitory computer-readable storage medium storing programs for causing a processor of the photography support device recited in claim 7 to execute a process of each unit of the photography support device.
